(19) United States
(12) Patent Application Publication
(10) Pub. No.: US 2017/0330044 A1
(43) Pub. Date: Nov. 16, 2017

(54) THERMAL MONITORING IN AUTONOMOUS-DRIVING VEHICLES

(71) Applicant: GM Global Technology Operations LLC, Detroit, MI (US)

(72) Inventors: Ariel Telpaz, GIVAT HAIM MEUHAD (IL); Gila Kamhi, ZICHRON YAAKOV (IL)

(21) Appl. No.: 15/499,388

(22) Filed: Apr. 27, 2017

Related U.S. Application Data
(60) Provisional application No. 62/334,123, filed on May 10, 2016.

(51) Int. Cl. G06K 9/00; G05D 1/00; H04N 5/33; G06K 9/20; B60K 37/02

(52) U.S. Cl. CPC G06K 9/00845; H04N 5/33; G06K 9/2018; G05D 1/0088; B60K 2350/1028; B60K 37/02

(57) ABSTRACT

A system managing vehicle operations based on thermal data. The system includes a thermal camera arranged in the vehicle to sense intra-vehicle thermal conditions. The system also includes a hardware-based storage device including a thermal-data analysis module that, when executed by a hardware-based processing unit, determines, based on the intra-vehicle thermal data, an activity or state of one or more vehicle occupants. The storage device may also include: an action module that, when executed, determines an output action based on the activity or state; and an output-interface module that, when executed, initiates performing the output action. The storage device may also include In various embodiments, the hardware-based storage device includes a database module that, when executed, obtains pre-stored occupant data corresponding to an occupant, and determining the output action is based on the pre-stored occupant data and occupant activity or state determined.

### TECHNICAL FIELD

The present disclosure relates generally to monitoring passenger activity in vehicles of transportation and, more particularly, to systems and processes for monitoring passenger activity in autonomous vehicles using sensed thermal characteristics within the vehicle. In various embodiments, the technology includes performing an action corresponding to the passenger activity determined, such as changing autonomous-driving functions, interacting with the passenger in an appropriate manner, or notifying authorities or a vehicle owner. Goals include improving passenger safety and experience.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace, markets for fully-autonomous taxi services and shared vehicles are developing. In addition to becoming familiar with the automated functionality, customers interested in these services will need to become accustomed, not only to riding in an autonomous vehicle, but also being driven by a driverless vehicle that is not theirs, and in some cases, with other passengers whom they may not know.

Uneasiness with automated-driving functionality, and possibly also with the shared-vehicle experience, can lead to reduced use of the autonomous driving capabilities, such as by the user not engaging, or disengaging, autonomous-driving operation. Or the user may discontinue or not commence a shared-vehicle ride. In some cases, the user continues to use the autonomous functions, whether in a shared vehicle, but with a relatively low level of satisfaction.

Levels of adoption can also affect marketing and sales of autonomous vehicles. As users' trust in autonomous-driving systems and use of shared autonomous vehicles increases, users are more likely to purchase an autonomous-driving-capable vehicle, schedule an automated taxi, share an automated vehicle, model doing the same for others, or provide recommendations to others to purchase an autonomous-driving product or service.

### SUMMARY

The system includes at least one thermal sensor for monitoring activity of passengers of a vehicle of transportation, such as a fully automated vehicle.

The system includes computing hardware to process various inputs including passenger identification and results of the thermal-activity monitored.

The system is configured to produce any of a wide variety of outputs based on the sensed input, and any identification information. Example output actions include placing or keeping the vehicle in a mode disallowing driving until a problematic situation, indicated by circumstances identified by the thermal monitoring, is addressed. Another example system output action is stopping the vehicle if already driving, to address the situation.

Another example system output action is providing a notification to one or more of the passengers—such as a calming message to passenger A, or an alert to passenger B indicating that the vehicle is approaching their stop, or a warning to passenger C about passenger D.

Still another example system output action is providing a notification to a remote user, such as to a parent, by way of a personal computing device or phone of theirs, or to a computing system or phone of a company owning or operating a subject shared vehicle.

Yet another example system output action is communicating with authorities about any perceived criminal behavior or emergency situation. Authorities can include such as first responders, customer-service center or, again, a parent, or vehicle owner or operator, for instance.

Still yet another example system output action is modifying vehicle settings, such as heating, ventilation, and air-conditioning (HVAC) settings or infotainment settings—e.g., volume or radio channel.

Output actions may also include determining to disallow a particular passenger from using the vehicle or vehicle service again, such as in response to continued passenger misconduct after repeated warnings;

In various embodiments, output actions include creating or updating a user profile, stored locally or remotely, with data indicating user characteristics—thermal distribution for a user body over time. The data may indicate, for instance, that the user tends to sleep when being driven home after work, and their reactions to conditions, which may also be indicated by body thermal readouts to conditions. As an example of the latter scenario, the system may determine that a user body temperature tends to rise during highway driving, indicating possible discomfort with automated highway driving and/or highway driving in general. In this case, the system is in one embodiment configured to, based on this data, or this and other data, establish a preference for non-highway driving in routing, and/or establish a setting causing the vehicle to take steps to calm the user. As examples for calming, the vehicle may increase following distance, drive slower, or provide calming reassurances, by voice, music, climate, the like, or other.

The vehicle system, or local or remote systems—phone apps, remote servers, etc.—are in various embodiments configured to learn about the user based on sensed thermal conditions related to the user during vehicle use. The characteristics can be paired with relevant context, such as the user activity or user state at the time, vehicle state, operation, or maneuver at the time, the like or other. The learning may be performed using any suitable manner, such as by using computational intelligence, heuristics, the like or other.

The learned information can be applied in future scenarios to better serve the user on future rides, whether in the same vehicle. The learned information in a contemplated embodiment is also used, in an anonymous manner, to improve other users' driving experiences, such as by consideration by a vehicle providing a shared ride to the first user and one or more other users, or by a remote server collecting data from numerous users for improving algorithms and data sets used by vehicle operator systems and vehicle systems to provide better driving experiences for users.

In one aspect, the system, for implementation at a vehicle of transportation, include a thermal camera arranged in the vehicle to sense intra-vehicle thermal conditions, yielding intra-vehicle thermal data, and a hardware-based storage device. The storage device includes a thermal-data analysis module that, when executed by a hardware-based processing unit, determines, based on the intra-vehicle thermal data, an activity or state of one or more vehicle occupants.

In various embodiments, the storage device also includes an action module that, when executed by the hardware-based processing unit, determines an output action based on the activity or state of at least one of the vehicle occupants.

The storage device in various implementations includes an output-interface module that, when executed by the hardware-based processing unit, initiates performing the output action determined.

In various embodiments, the hardware-based storage device includes a database module that, when executed by a hardware-based processing unit, obtains pre-stored occupant data corresponding to one of the occupants of the vehicle. And determining the output action may thus be based on occupant data—such as user-profile data, or user settings or preferences—obtained and the occupant activity or state determined.

In various embodiments, the thermal-data analysis module, when executed by the hardware-based processing unit determines, based on the intra-vehicle thermal data, an activity or state for each of multiple vehicle occupants. And the action module, when executed by the hardware-based processing unit, determines the output action based on the activity or state of at least one of the multiple vehicle occupants.

The thermal-data analysis module, in determining the activity or state of one or more vehicle occupants, may determine that at least one of the vehicle occupants is sleeping, misbehaving, not feeling well, or uncomfortable.

In various embodiments, the thermal-data analysis module, in determining the activity or state of one or more vehicle occupants, determines that at least one of the vehicle occupants is uncomfortable. And the thermal-data analysis module, in determining the activity or state of one or more vehicle occupants, may determine that at least one of the vehicle occupants is uncomfortable with a present or recent vehicle driving maneuver.

In various embodiments, the action module, in determining the output action based on the activity or state of at least one of the vehicle occupants, determines to provide an alert or notification to at least one vehicle occupant regarding the activity or state determined. And the output-interface module, in initiating performing the output action determined, initiates providing the alert or notification by way of vehicle communication hardware or an occupant device.

The action module, in determining the output action based on the activity or state of at least one of the vehicle occupants, may determine to change a vehicle driving setting affecting autonomous driving. And the output-interface module, in initiating performing the output action determined, would then initiate changing the driving setting.

In various embodiments, the action module, in determining the output action based on the activity or state of at least one of the vehicle occupants, determines to deliver a message to an authority of supervisory entity regarding the activity or state determined, and the output-interface module, in initiating performing the output action determined, initiates delivering the message to the entity.

The entity may include, for instance, any one or more of a first-responder; a remote customer-service center, a co-worker of the occupant, a relative of the occupant, and a friend of the occupant.

In various implementations of the present technology, the user activity or state includes occupant misconduct; the action module, in determining the output action based on the activity or state of at least one of the vehicle occupants, determines to disqualify the occupant from present or future use of the subject vehicle or a group of vehicles including the subject vehicle; and the output-interface module, in initiating performing the output action determined, initiates disqualifying the occupant from present or future use of the subject vehicle or a group of vehicles including the subject vehicle.

In various implementations, the thermal-data analysis module, in determining the activity or state of one or more vehicle occupants based on the intra-vehicle thermal data determines that an occupant is sleeping; the action module, in determining the output action based on the activity or state of at least one of the vehicle occupants, determines to provide an alert to awaken the occupant sleeping; and the output-interface module, in initiating performing the output action determined, initiates providing the alert by way of a vehicle human-machine interface.

In various implementations of the present technology, the thermal-data analysis module, in determining the activity or state of one or more vehicle occupants based on the intra-vehicle thermal data determines that an occupant is sleeping; the action module, in determining the output action, determines, based also on data indicating that a stop for the sleeping occupant is approaching or has been reached, to provide a notification, to the occupant, as part of awakening the occupant sleeping and advising the occupant being awaken of the stop; and the output-interface module, in initiating performing the output action determined, initiates providing the notification by way of vehicle communication hardware or an occupant device.

In embodiments, the action module, in determining the output action, determines, based on the intra-vehicle thermal data, to adjust a vehicle climate-control system; and the output-interface module, in initiating performing the output action determined, initiates adjusting the vehicle climate control system.

The action module, in determining the output action, may determine, based on the intra-vehicle thermal data, to adjust a vehicle infotainment system. And the output-interface module, in initiating performing the output action determined, initiates adjusting the vehicle infotainment system.

In various implementations of the present technology, the output action is a second output action; the thermal-data analysis module, when executed by the hardware-based processing unit, determines, based on the intra-vehicle thermal data, an identity of an analyzed person being one of the occupants or attempting to become a vehicle occupant; and the action module, when executed by the hardware-based processing unit, performs multiple functions; and an output-interface module that, when executed by the hardware-based processing unit, initiates performing the first output action and the second output action. The functions include, for instance, comparing the identify determined to an expected identity for the analyzed person, yielding a comparison, and determining a first output action in response to the comparison revealing a mismatch between the identity determined and the expected identity.

In various embodiments, the first output action comprises at least one action selected from a group consisting of notifying the analyzed person of the mismatch; notifying at least one vehicle occupant, not including the analyzed person, of the mismatch; notifying a remote entity of the mismatch; locking vehicle doors; sounding a vehicle alarm; establishing a setting so that the vehicle is not driven presently; and stopping vehicle driving if driving has already commenced.

The action module, when executed by the hardware-based processing unit, may obtain the expected identify from a vehicle itinerary or manifest indicating persons expected for present vehicle use.

Other aspects of the present technology will be in part apparent and in part pointed out hereinafter.

### DESCRIPTION OF THE DRAWINGS

FIG. 1 illustrates schematically an example vehicle of transportation, with local and remote computing devices, according to embodiments of the present technology.

FIG. 2 illustrates schematically select details of a vehicle computing system of FIG. 1, being in communication with at least one sensor and possibly with the local and remote computing devices.

FIG. 3 shows another view of the vehicle, emphasizing example memory components.

FIG. 4 shows interactions between the components of FIG. 3, including with external systems.

FIG. 5 shows an example thermal image of three vehicle occupants—one front row and two second-row occupants.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Technology Introduction

The present disclosure describes, by various embodiments, algorithms, systems, and processes for analyzing vehicle occupant activity via thermal characteristics of the occupant. In various embodiments, the technology is implemented in autonomous-driving vehicles, and in some cases with shared autonomous vehicles.

While select examples of the present technology describe transportation vehicles, or modes of travel, and particularly automobiles, the technology is not limited by the focus. The concepts can be extended to a wide variety of systems and devices, such as other transportation or moving vehicles including aircraft, watercraft, busses, the like, and other.

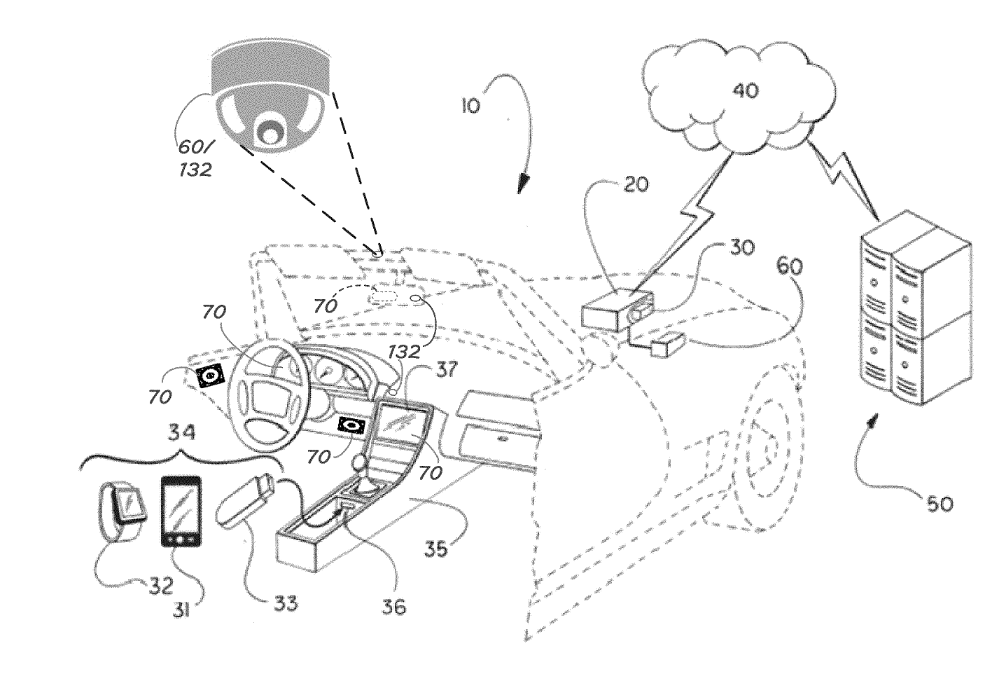

### II. Host Vehicle—FIG. 1

Turning now to the figures and more particularly the first figure, FIG. 1 shows an example host vehicle of transportation 10, provided by way of example as an automobile. The vehicle is in various embodiments a fully autonomous vehicle, capable of carrying passengers along a route without a human intervention.

The vehicle 10 includes a hardware-based controller or controller system 20. The hardware-based controller system 20 includes a communication sub-system 30 for communicating with mobile or local computing devices 34 and/or external networks 40.

By the external networks 40—such as the Internet, a local-area, cellular, or satellite network, vehicle-to-vehicle, pedestrian-to-vehicle or other infrastructure communications, etc.—the vehicle 10 can reach mobile or local computing devices 34 or remote systems 50, such as remote servers.

Example local computing devices 34 include a user smartphone 31, a user wearable device 32, and a USB mass storage device 33, and are not limited to these examples. Example wearables 32 include smart-watches, eyewear, and smart-jewelry, such as earrings, necklaces, lanyards, etc. User devices can be used by the system (e.g., controller 20) in various ways, including to identify a present or potential passenger of the vehicle 10, and to provide a notification to the user.

Another example local device is an on-board device (OBD), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

One or more OBDs can be considered as local devices, sensors of the sub-system 60, or both local devices and sensors of the sub-system 60 in various embodiments. And local devices 34 (e.g., user phone, user wearable, or user plug-in device) can be considered as sensors 60 as well, such as in embodiments in which the vehicle 10 uses local-device-sensor data provided by the local device. The vehicle system can use data from a user smartphone, for instance, indicating user-physiological data sensed by a biometric sensor of the phone.

The sensor sub-system 60 includes any of a wide variety of sensors, such as cabin-focused sensors 132, such as microphones and cameras configured to sense presence of people, other living creatures, activities of people, and inanimate objects. This particular subset of sensors 132 is described more below.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 may include a central console, a dashboard, and an instrument panel. The mounting structure 35 in various embodiments includes a plug-in port 36—a USB port, for instance, or a visual display 37, such as a display including a touch-sensitive, input/output, human-machine interface (HMI) screen.

The sensor sub-system 60 includes sensors providing information to the controller system 20. Sensor data relates to features such as vehicle operations, vehicle position, and vehicle pose, user characteristics, such as biometrics or physiological measures, and environmental-characteristics pertaining to a vehicle interior or outside of the vehicle 10.

For sensing user characteristics, the sensor sub-system 60 includes one or more sensors capable of sensing thermal characteristics within a cabin of the vehicle 10. An example thermal sensor is a thermographic camera, also referred to as a thermal-imaging sensor or camera, and an infrared camera is one type.

Infrared cameras form images using infrared radiation—wavelengths up to 14,000 nanometers (nm). Conventional cameras form images based on visible light, in a 400-700 nm-wavelength range.

The thermal sensor/s is/are preferably include a wide-angle camera.

In various embodiments, one or more thermal sensors are configured and arranged in the vehicle in any other way to sense a large percentage of the vehicle interior.

The vehicle 10 also includes cabin output components 70, such as acoustic speakers, an instruments panel, and a display screen. Any display screen may be touch-sensitive for receiving user input, and in various embodiments includes any of a dashboard, or center-stack, display screen (reference numeral 37 in FIG. 1), a rear-view-mirror screen (indicated by one of the numerals 70 in FIG. 1), or any other visual display device or component that is part of or in communication with the vehicle 10.

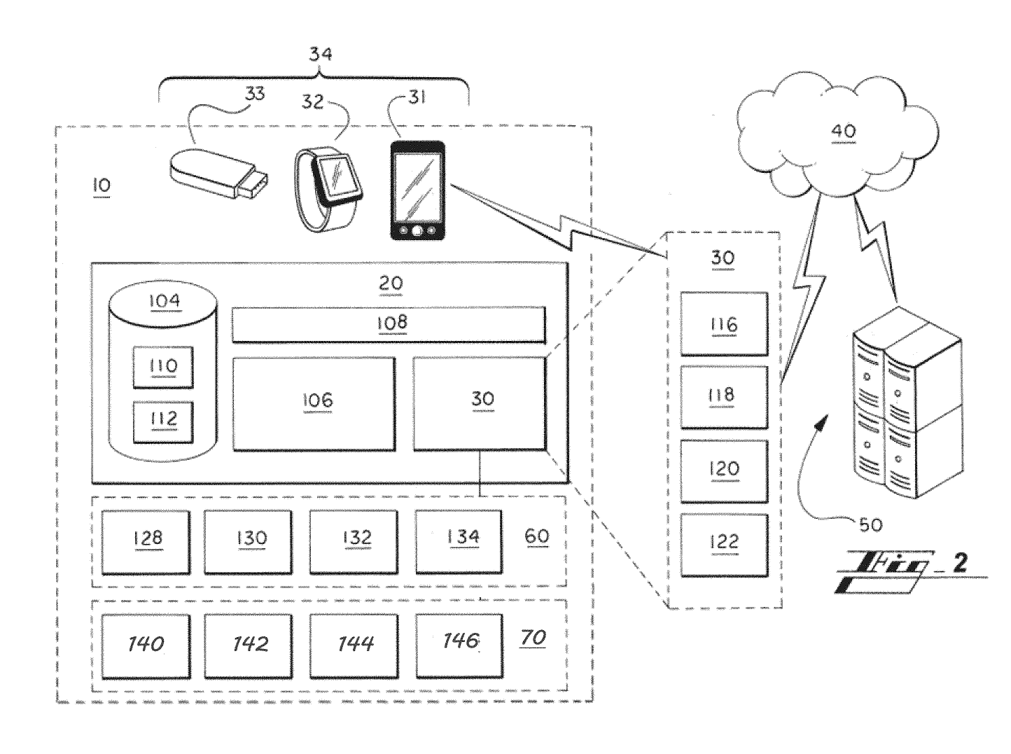

### III. On-Board Computing Architecture—FIG. 2

FIG. 2 illustrates in more detail the hardware-based computing or controller system 20 of FIG. 1. The controller system 20 can be referred to by other terms, such as computing apparatus, controller, controller apparatus, or such descriptive term.

The system 20 can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 includes any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

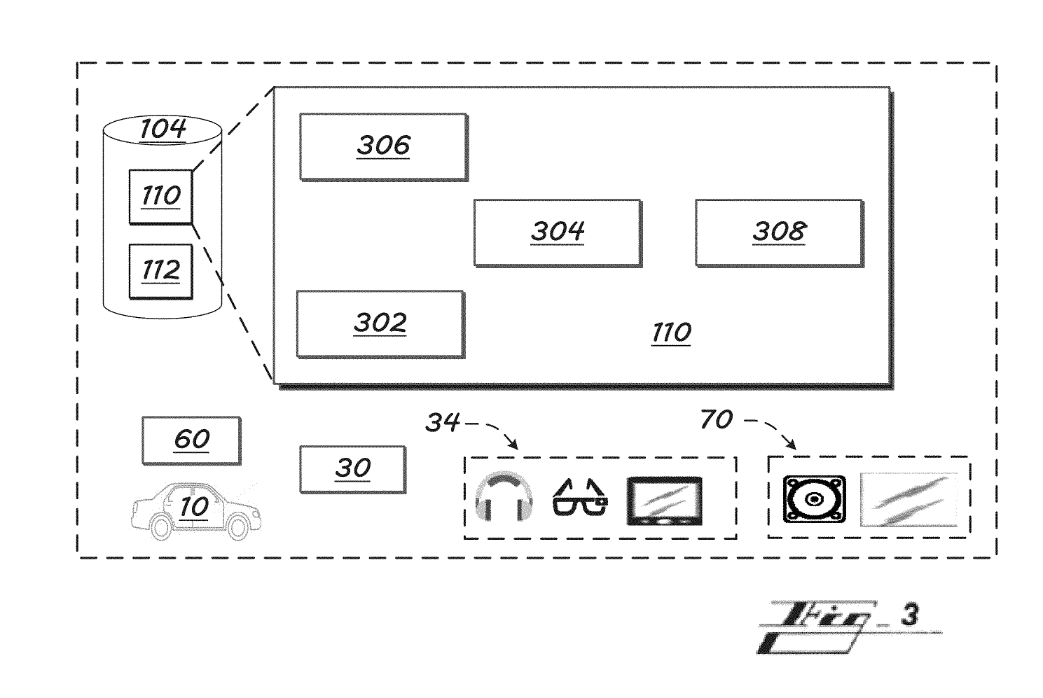

The data storage device 104 includes one or more storage modules 110 storing computer-readable code or instructions executable by the processing unit 106 to perform the functions of the controller system 20 described herein. The modules and functions are described further below in connection with FIGS. 3-5.

The data storage device 104 in some embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with local and external devices and networks. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controller system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle controller system 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to the vehicle and in communication with the vehicle.

Example remote systems 50 include a remote server (for example, application server), or a remote data, customer-service, and/or control center. A user computing or electronic device 34, such as a smartphone, can also be remote to the vehicle 10, and in communication with the sub-system 30, such as by way of the Internet or other communication network 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 130, such as radar or sonar, directed away from the vehicle, such as for supporting autonomous driving.

Visual-light cameras 128 directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 128 and the range sensor 130 may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 130 may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned one or more cabin sensors 132. These may be configured and arranged—e.g., configured, positioned, and in some cases fitted, in the vehicle in any of a variety of ways, to sense any of people, activity, cabin environmental conditions, or other features relating to the interior of the vehicle 10.

Example cabin sensors 132 include microphones, in-vehicle visual-light cameras, seat-weight sensors, and sensors for measuring user salinity, retina or other user characteristics such as biometrics or characteristics, and sensors for measuring conditions of the intra- and extra-vehicle environments.

In various embodiments, the cabin sensors 132 include one or more temperature-sensitive cameras or sensors. As mentioned, an example thermal sensor is a thermographic camera, or thermal-imaging or infrared camera arranged in the vehicle 10 to sense thermal conditions within the vehicle and, particularly, occupant thermal conditions.

In some embodiments, thermal cameras are positioned preferably at a high position in the vehicle 10. Example positions include on a rear-view mirror and in a ceiling compartment. A higher positioning reduces interference from lateral obstacles, such as front-row seat backs, blocking all or more/too much of second- or third-row passengers, or blocking all or more/too much of other things, such as pets in the vehicle, other live things, and inanimate things, such as a lit cigar or recently-filed handgun. Generally, a higher positioned thermal camera would be able to sense temperature of more of each passenger's body—e.g., torso, legs, feet.

Two example locations for the thermal camera are indicated in FIG. 1 by reference numeral 132—one at rear-view mirror, and one at the vehicle header.

Other example sensor sub-systems 60 include dynamic vehicle sensors 134, such as an inertial-momentum unit (IMU), having one or more accelerometers, for instance, wheel sensors, and a sensor associated with a steering system, such as a sensor measuring steering wheel angle, change of same, or rate of the change.

The sensor sub-system 60 can include any sensor for measuring a vehicle pose or other dynamics, such as position, speed, acceleration, or height.

The sensors 60 can include any known sensor for measuring an environment of the vehicle, including those mentioned above, and others, such as a precipitation sensor for detecting whether and how much it is raining or snowing, a temperature sensor, etc.

Sensors for sensing user characteristics include those referenced above, and any biometric sensor, such as a retina or other eye scanner or sensor, thermal sensor, fingerprint scanner, facial-recognition sub-system including a camera, microphone associated with a voice recognition sub-system, a weight sensor, salinity sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a touch-sensitive display 37, microphones, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to sound speakers 140, visual displays 142, such as the instruments panel, center-stack display screen, and rear-view-mirror screen, and haptic outputs 144, such as steering wheel or seat vibration actuators.

The fourth element 146 in this section 70 is provided to emphasize that the vehicle can include any of a wide variety of other in output components, such as components providing an aroma or light into the cabin.

### IV. Additional Vehicle Components—FIG. 3

FIG. 3 shows an alternative view of the vehicle 10 of FIGS. 1 and 2 emphasizing select example memory components, and showing associated devices.

As mentioned, the data storage device 104 includes one or more modules 110 for performance of the processes of the present disclosure. And the device 104 may include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

Example modules 110 include:
an input-interface module 302;
an activity or action module 304;
a database module 306; and
an output-interface module 308.

Other vehicle components shown include the vehicle communications sub-system 30 and the vehicle sensor sub-system 60.

Various input devices and systems act at least in part as input sources to the modules 110, and particularly to the input interface module 302 thereof.

Example inputs from the communications sub-system 30 include identification signals from mobile devices, which can be used to identify or register a mobile device or corresponding user, to the vehicle 10, or at least preliminarily register the device or user, to be followed by a higher-level confirmation of identify or registration.

Example inputs from the vehicle sensor sub-system 60 include and are not limited to:
bio-metric sensors providing bio-metric data regarding vehicle occupants, such as skin or body temperature for each occupant;
vehicle-occupant input devices, or human-machine interfaces (HMIs), such as a touch-sensitive screen, button, knob, microphone, etc.;
cabin sensors providing data about conditions or characteristics within the vehicle 10, such as cabin temperature, occupant weight, or activity, such as from temperature sensors, in-seat weight sensors, and motion- or thermal-detection sensors;
ambient environment sensors providing data about conditions outside of a vehicle, such as from external camera and distance sensors—e.g., LiDAR, radar; and
Sources separate from the vehicle 10, such as local devices 34, devices worn by pedestrians, other vehicle systems, local infrastructure (local beacons, cellular towers, etc.), satellite systems, and remote systems 34/50. These sources in various embodiments provide any of a wide variety of data, such as user-identifying data, user-history data, user selections or user preferences, and contextual data—weather, road conditions, navigation, etc.
The data received can also include program or system updates. Remote systems can include, for instance, application servers, corresponding to application(s) operating at the vehicle 10, or any relevant user device 34, servers or other computers of a user or authority—e.g., parent, work supervisor or vehicle owner or operator, such as that of a taxi company operating a fleet of which the vehicle 10 belongs, or that of an operator of a ride-sharing service, or a customer-control center system, such as systems of the OnStar® control center mentioned, or a vehicle-operator system.

The view also shows example vehicle outputs 70, and user devices 34 that may be positioned in the vehicle 10. Outputs 70 include and are not limited to:
vehicle-dynamics actuators, such as those affecting autonomous driving (vehicle brake, throttle, steering, etc.);
vehicle climate actuators, such as those controlling the HVAC system and any of cabin temperature, humidity, zone outputs, fan speed(s), etc.; and
local or mobile devices 34 and remote networks/systems 40/50, to which the system may provide a wide variety of information, such as user-identifying data, user-biometric data, user-history data, contextual data (weather, road conditions, etc.), instructions or data for use in providing notifications, alerts, or messages to the user or relevant entities such as authorities and, whether considered an authority, first responders, parents, an operator or owner of a subject vehicle 10, or a customer-service center system such as of the OnStar® control center.

The modules, sub-modules, and their functions are described more below.

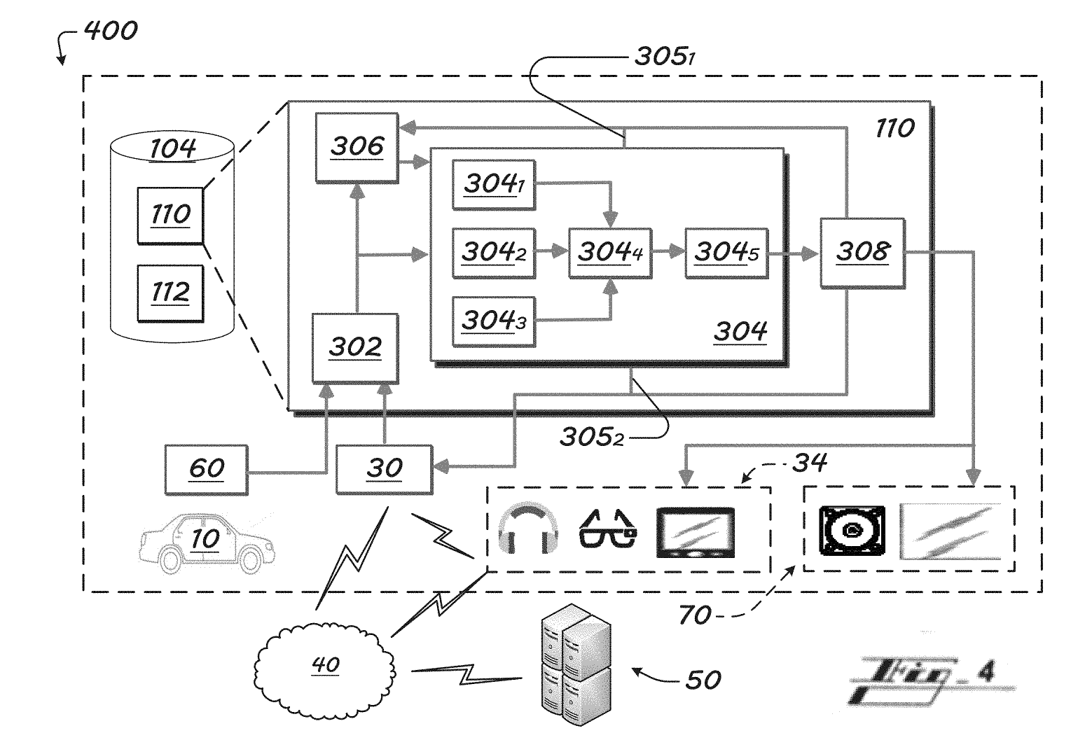

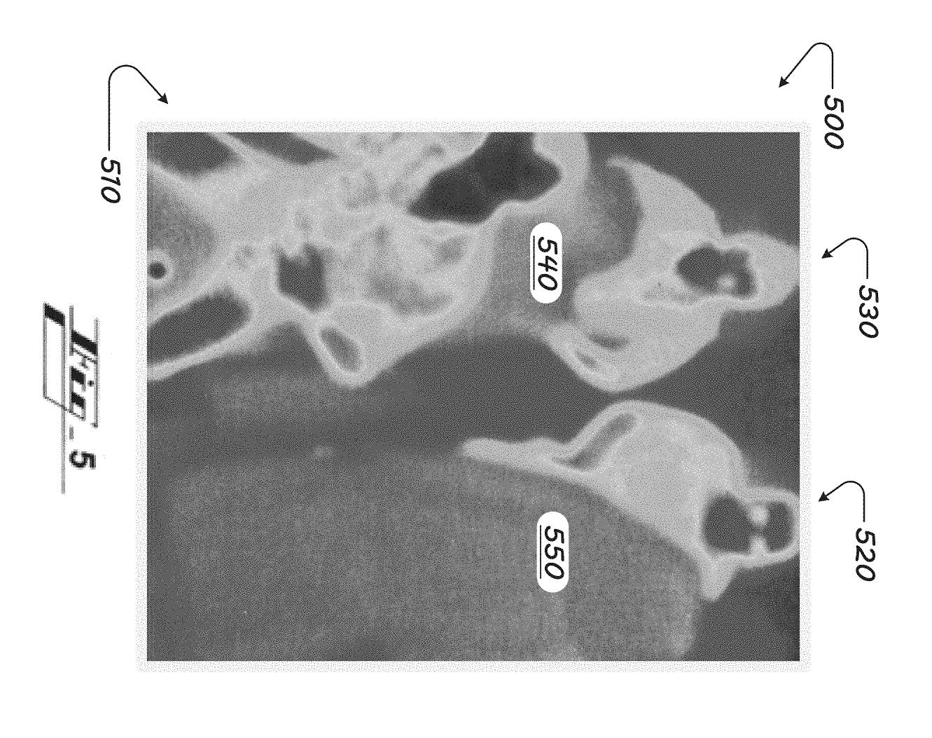

### V. Algorithms and Processes—FIGS. 4 and 5

V.A. Introduction to the Algorithms

FIG. 4 shows an example algorithm, represented schematically by a process flow 400, according to embodiments of the present technology. Though a single process flow is shown for simplicity, any of the functions or operations can be performed in one or more or processes, routines, or sub-routines of one or more algorithms, by one or more devices or systems.

It should be understood that the steps, operations, or functions of the processes 400 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes 400 can be ended at any time.

In certain embodiments, some or all operations of the processes 400 and/or substantially equivalent operations are performed by a computer processor, such as the hardware-based processing unit 106, executing computer-executable instructions stored on a non-transitory computer-readable storage device, such as any of the data storage devices 104, or of a mobile device, for instance, described above.

V.B. System Components and Functions

FIG. 4 shows the components of FIG. 3 interacting according to various exemplary algorithms and process flows.

The input module 302, executed by a processor such as the hardware-based processing unit 106, receives any of a wide variety of input data or signals, including from the sources described in the previous section (IV.).

Input data is passed, after any formatting, conversion, or other processing at the input module 302, to the activity module 304.

The activity module 304 in various implementations also requests (pull), receives without request (push), or otherwise obtains relevant data from the database module 306. The database module 306 may include, or be part of or in communication with storage portions of the vehicle 10, such as a portion storing the ancillary data mentioned. The ancillary data may, as mentioned, include one or more user profiles. The profiles can be pre-generated by the system processor, or received from a remote source such as the server 50 or a remote user computer, as examples.

The profile for each user can include user-specific preferences communicated to the system by the user, such as via a touch-screen or microphone interface of the vehicle 10 or user device 34.

Preferences include any settings affecting a manner by which the system interacts with the user or interacts (shares data) with a non-vehicle system, such as a remote server or user device. Example preferences include volume, tone, or other acoustic-related preferences for media delivery, and type or volume of notifications provided to the user, as just a few examples.

Data from the database module 306 can also include historic data representing past activity between the system and a user, between the system and other users, or other systems and these or other users, for instance. As an example, if on repeated occasions, in response to receiving a certain notification, a user turns down a volume for media being provided to their acoustic zone, the system can generate historic data, a preference, or setting, corresponding to that user, requiring the system to use a lower-volume for the notification.

Preferences can also be received from a remote profile, such a profile stored at a user mobile device 34 or a remote server 50, and local and remote profile features can be synchronized or shared between the vehicle 10 and the remote server 50 or mobile device 34.

Based on the various inputs, the activity module 304 performs various operations described expressly and inherently herein. The operations can be performed by one or more sub-modules, and five (5) are shown by way of example—304₁₋₅:
ride-scheduling sub-module 304₁,
pre-registration sub-module 304₂,
registration sub-module 304₃;
thermal-analysis sub-module 304₄; and
action-determination sub-module 304₅.

The ride-scheduling sub-module 304₁ receives information indicating a planned ride in the vehicle 10. If the vehicle 10 is a taxi or ride-sharing vehicle, for instance, ride-plan data can indicate people who have signed up for a ride in the vehicle 10 at a certain time. Ride-plan data can include a route or itinerary for the planned ride.

The activity module 304 can use the ride-plan data in a variety of ways. The activity module 304 in various embodiments uses the ride-plan data to confirm that each passenger entering the vehicle 10 is identified in the ride plan, as described more below.

The pre-registration sub-module 304₂ and the registration sub-module 304₃ can in various embodiments be viewed to process at least two types of data: course data and fine data, having relatively lower and higher levels of security checks.

The pre-registration sub-module 304₂ may be configured to perform the mentioned pre-registration of a user approaching, entering, or occupying the vehicle before a ride commences, or after the ride has started. The pre-registration can include, as one example, receiving an identifying communication from a mobile device, such as a smartphone, radio-frequency identification (RFID) tag, or smartwatch, carried or worn by each user. In this case, the pre-registration is considered a course, or relatively low-level security check because, for instance, it is possible that, while an owner of a mobile device (e.g., a parent) has pre-scheduled a taxi or shared ride in a vehicle 10, another person (e.g., teenage child) could enter the vehicle 10 holding the same mobile-device.

The pre-registration in another contemplated embodiment includes the system soliciting or otherwise receiving from the person a code via a vehicle interface, such as by a vehicle microphone, keypad, or personal mobile device, as a few examples. The code may have been provided to the user with a ride confirmation, for instance, such as a paper or electronic ticket or other conformation. Or the code may be a pre-established user code or password. A code-based pre-registration is considered a relatively low-level security check because another person may have obtained the code.

The pre-registration in another contemplated embodiment includes occupant weight, height, or other physical characteristics, as measured by a seat-weight sensor, camera, radar, etc.

The pre-registration is helpful in many scenarios. As an example, the vehicle system can be programmed to perform the pre-registration on users as they approach or arrive at a vehicle 10, before entering. If a person is not able to pass the pre-registration, the system can take any of a variety of security-enforcement actions (using the action-determination sub-module 304₅, described more below), such as to: keep the person from entering the vehicle (e.g., locking vehicle doors); or provide a notification. The notification may be to, for instance, authorities, a customer-service center (e.g., an OnStar® Center), or a vehicle owner or remote operator, or others, such as persons in or near the vehicle by, for instance, the vehicle projecting an audible message advising scheduled passengers that a non-scheduled person is attempting to join the ride.

The registration sub-module 304₃ performs a security check. If the check proceeds a pre-registration, the check may be a higher-level, or stricter, check. In a contemplated embodiment, the registration has a similar level of security as that of the pre-registration, with a difference between the two being that the registration occurs later.

In various embodiments, the registration function includes a bio-metric validation. The bio-metric validation may analyze any one or more of retina, finger print, facial, or voice characteristics of persons, for instance.

In a contemplated implementation, the registration includes a password or code, whether a prior pre-registration included a different code. The pre-registration could include a code from a paper or e-ticket, for instance, and the registration code can include a user-set password, or vice versa.

In various implementations, then, the system includes both a pre-registration sub-module 304₂ and a separate registration sub-module 304₃. In other implementations, the system includes a single sub-module comprising both pre-registration and registration functions. In still another implementation, there is no pre-registration function, only a single registration for each ride, and the level of security thereof can be set at any desired level—anywhere between a very strict, high level—e.g., retina scan—and a relatively low level.

The thermal-analysis sub-module 304₄ retrieves, receives, or otherwise obtains thermal data indicating thermal characteristics within the vehicle 10. In one embodiment, the thermal analysis is performed only after the registration function(s) have been satisfied—i.e., in response to determining that each occupant is an approved passenger of the vehicle 10.

The thermal data is retrieved from one or more thermal sensors, such as the thermal sensors described above—e.g., thermographic, thermal-imaging, or infrared camera. The thermal data indicates characteristics of any object in the vehicle, within view of the sensor(s), or in some cases even if partially blocked, that is producing heat. In various embodiments, this includes objects emanating infrared (IR) radiation, having wavelengths between about 700 nm (upper edge of the visible-light spectrum) and about 14,000 nm. The thermal sensor(s) can detect heat emitting from any humans in the car, as well as other living occupants, such as pets, and other items, such as an electronic cigarette in use.

The thermal data in various embodiments includes detailed information, such as pixel-by-pixel information, indicating not only heat emitted by an occupant, or other thing, but various temperatures being emitted from particular portions of the occupant or thing. The data can be represented in a variety of ways, such as by a color image showing various temperatures by corresponding colors. For instance, black can represent no temperature emission, blue would represent a low temperature, purple, a medium temperature, red, a higher color, and any number of intermediary color gradients representing temperatures between.

While the figures appended hereto may be reproduced in black and white, the possibility of the system providing color images, for being perceived by any person or system should be understood. The persons or systems perceiving the images may include, for instance, passengers, and personnel or computing device of authorities (police, etc.), parents, vehicle owners or operators, or other.

FIG. 5 shows an example thermal-sensor image 500, from an in-vehicle thermal sensor 132. The image 500 shows three passengers 510, 520, 530 sensed by a thermal video camera.

The image 500 may include low-temperature or no-temperature areas, such as in connection with vehicle seats 540, 550 or other structures positioned between the thermal sensor and occupants or other heat-emitting object. Such blocking is generally not preferred, as it limits the amount of information that can be collected about vehicle occupants, such as by blocking lower torso, legs, and feet of occupants, or other objects that may be blocked by the seat or other obstacle.

In a contemplated embodiment, the thermal sensor is capable of sensing thermal characteristics through various intermediate materials. Of course, thermal cameras can sense human heat emitted through typical clothing. Some present or future thermal cameras can detect thermal characteristics, emitted from a person or object, that are transmitted through more substantial objects, such as a car seat, briefcase, etc.

On the other hand, some blocking can be informative. Information indicating blocking can be used by the system in determining a present circumstance, and one or more appropriate actions to take, such a providing a warning to other occupants, to a vehicle operating company, or to first responders. As an example, if a user is holding a weapon, such as a knife or firearm, the weapon can be determined present—e.g., presence of an object that appears to be, is likely, or may be, a weapon—based on the thermal data showing an object (or an object having a particular size and/or shape) blocking the thermal radiation emitted by the passenger.

The thermal data can indicate a wide variety of circumstances relevant to the system, such as relevant to occupant safety, occupant enjoyment, and vehicle operation, as just a few examples.

As another example, the thermal data can indicate a condition of a passenger, such as a passenger having a low (or unusually low) or high (or unusually high) body temperature, of a temperature beyond a pre-set threshold, or in a pre-set range. In one embodiment, the system is configured to recognize if a certain portion of a user, such as a hand, forehead area, or back of neck, has a temperature beyond a pre-set threshold, or in a pre-set range.

Thermal data over time may also indicate movement of objects within the vehicle 10. The data over time may indicate an improper or unsafe situation, such as assault or battery, of one passenger on another, or other passenger misconduct—e.g., behavior that is against the law, against rules of the vehicle operator, or otherwise unsafe or deemed improper.

Thermal data over a period of time can also indicate changes in occupant temperature—skin or body temp, for instance. The system is in various embodiments configured to analyze the thermal data over time and determine whether it indicates relevant circumstances, such as a rising occupant body temperature, which may indicate passenger sickness or stress—such as stress in connection with a recent autonomous-vehicle-driving maneuver. The change in occupant temperature may also indicate a situation involving another passenger, such as a battery situation, as mentioned.

Or the data may indicate a passenger state, such as that the passenger is sleeping, inebriated, or in a drug-induced state.

If a user is determined to be sleeping, for instance, and the vehicle is approaching a destination for the user, the system may begin to gently awaken the passenger. The system may also then, or therein, advise the passenger that their stop is approaching.

The action-determination sub-module 304₅ determines one or more actions, such as those mentioned above, to take based on results of the analysis of the thermal-analysis sub-module 304₄. In various embodiments, the sub-module 304₅ determines an action based on thermal analysis and/or other inputs. The other inputs can include historic or other stored data from the database module 306, or from a remote source 50 such as a remote server or user computer. Other sources include user mobile devices, and vehicle sensors, such as vehicle-dynamics or -operations sensors or sub-systems, indicating speed, vehicle location, temperature, etc. The other inputs may include user profile data, historic user data, user preference or settings, which may not be part of a profile, per se, the like, or other. Many of these are described above.

As mentioned, output actions can include providing a warning alert to vehicle occupants or other systems (mobile phone, remote computer) or other parties, such as parents, a vehicle owner or operator, authorities, or a customer-service center.

Other example output actions include adjusting vehicle settings, such as adjusting how the vehicle is driving autonomously (e.g., speed, cornering), settings of an infotainment system, such as volume, and vehicle climate/HVAC settings, such as lowering a temperature if one or more occupants skin or body temperature is high, or vice versa.

The output-interface module 308 formats, converts, or otherwise processes output of the activity module 304 prior to delivering resulting output (instructions, data, messages, notifications, alerts, etc.) to any of various output components.

The output components in various embodiments includes the system database(s) 306 and/or extra-system databases, such as a remote server databases. The local database(s) 306 can also be updated directly from the activity module 304, as indicated by path 305₁, 305₂ in FIG. 4.

The database 306 can, as mentioned, include user profiles, or if not in a profile, per se, preferences, or settings, such as of those referenced above regarding the database 306 and/or the ancillary data 112.

The data used for updating a database can include, a preference communicated expressly by a user, vehicle owner, vehicle operator, etc., or a preference determined by the system based on activity involving the user, as a few examples. Regarding activity involving the user, as mentioned, the system may determine, based on user temperature and/or other indicator, that the user responded negatively when the vehicle made a certain automated maneuver, such as passing another vehicle on the highway at high speed. The preference then may be to not make such maneuver.

As another example, the system may determine from trial and error, working with a user over time, that they sleep better when under certain music and/or climate conditions. The relationship can be stored in a user profile, and used when the system determines that the user would like to rest, such as whenever on a long-ride home in the evening, or whenever the user expressly advises the system that they'd like to rest. Similar arrangements can cover any number of such scenarios, such as if the person would like to be awoken on the way to work, by music, climate, etc.

Example communications and interactions are provided by the following chart:

| Context | Action |
|---|---|
| The thermal-analysis sub-module | The action-determination sub- |
| 304₄ of the activity module 304 | module 304₅ of the activity module |
| determines, based on thermal | 304, in response, determines to |
| data, that a passenger appears | turn down a volume of the radio, |
| sick or otherwise not feeling well. | lower cabin temperature via the |
| | vehicle hvac system, drive slower, |
| | corner less aggressively, and/or |
| | initiate transmission of a |
| | notification message, to a friend, |
| | co-worker, parent or other relative, |
| | indicating the apparent sickly |
| | condition or state. If the state is |
| | poor enough, autonomous driving |
| | adjustments may include a change |
| | of route, such as to straight home, |
| | or to an emergency facility. Each |
| | activity may be accompanied by |
| | notifications to the subject |
| | passenger, and possibly |
| | conversation between the vehicle |
| | and passenger to obtain |
| | information for diagnoses, for |
| | determining appropriate action |
| | (e.g., where to drive them), or to |
| | calm the passenger, for instance. |
| The thermal-analysis sub-module | The action-determination sub- |
| 304₄ determines based on thermal | module 304₅ of the activity module |
| data that a passenger is drinking | 304 in response determines to stop |
| alcohol in the vehicle 10, which is | the vehicle, notify the vehicle |
| against the law or against the | operator, a parent, or authorities. It |
| autonomous-taxi or ride-share | is contemplated that, in cases that |
| rules. The users thermal signature | are not illegal, the passenger may |
| may change, for instance, as they | be given a warning first. |
| become inebriated. And the | |
| thermal data may also show, such | |
| as by thermal emissions that are | |
| blocked by an object looking like a | |
| drink container (beer bottle, wine | |
| glass, cub, etc.) is being moved to | |
| the persons mouth. | |
| The thermal-analysis sub-module | The action-determination sub- |
| 304₄ of the activity module 304 | module 304₅ of the activity module |
| determines based on thermal data | 304 in response determines to stop |
| that a first passenger appears to | the vehicle, notify the vehicle |
| be committing a battery against | operator, a parent, or authorities. |
| (e.g., hitting) another passenger. | The action first or also include |
| The thermal data may show, for | communicating with the apparent |
| instance, that one occupant moved | victim, who may confirm the |
| in an apparently lunging manner | system determination of improper |
| toward another occupant, and | behavior, or discredit it, such as by |
| further apparently struck or | a child occupant indicating that he |
| grabbed the other, and may further | and his sister were just playing. |
| show that the second occupant | The system may also in |
| appears, by their movement and/or | communicate with one or both |
| changes in body temperature, to | passengers to determine more |
| be uncomfortable or injured, | about the situation, record sensed |
| | characteristics, such as thermal, |
| | visual, and/or audible information, |
| | which may be used in later |
| | investigations. The system may |
| | remind the passengers of a |
| | recording, which may dissuade |
| | improper behavior or calm one or |
| | both passengers. Such recordings |
| | would only be made legally, such |
| | as based on agreement with the |
| | user, or otherwise lawfully, such as |
| | if the vehicle is considered a public |
| | space, even if an automobile, as |
| | would be a subway train. |
| The thermal-analysis sub-module | The action-determination sub- |
| 304₄ of the activity module 304 | module 304₅ of the activity module |
| determines based on thermal data | 304 in response determines to stop |
| that a passenger appears to be | the vehicle, notify the vehicle |
| carrying a firearm. The thermal | operator, a parent, or authorities, |
| data may show, for instance, that | or if the law is not broken, simply |
| part of the heat sensed form a | to warn the first passenger to stop |
| person is blocked by an object | immediately. The system may also |
| having a shape like a firearm. | communicate with the passenger |
| | to determine more about the |
| | situation, such as whether the |
| | firearm is being carried legally |
| | (perhaps the individual is a law- |
| | enforcement officer, which may be |
| | verified in various ways, such as |
| | via connecting the passenger via |
| | call with local police. |
| | Conversations again may be |
| | recorded and used in any needed |
| | subsequent investigations. |
| The thermal-analysis sub-module | The action-determination sub- |
| 304₄ of the activity module 304 | module 304₅ of the activity module |
| determines based on thermal data | 304 in response determines to |
| that a passenger is sleeping. The | begin to gently awaken the |
| thermal data may show, for | passenger. The system may also |
| instance, that the user is emitting | then, or therein, advise the |
| heat in an amount or manner | passenger that their stop is |
| typical of sleeping or a lower | approaching. |
| activity rate, and/or that their body | |
| is in a position indicating that they | |
| may be sleeping. | |

### VI. Additional Structure, Algorithm Features, and Operations

In combination with any of the other embodiments described herein, or instead of any embodiments, the present technology can include any structure or perform any functions as follows:
i. The technology in various embodiments describes a system for automatic in-vehicle behavior identification using thermal data.
ii. The system allows the vehicle, and vehicle operators or authorities (parents, etc.) to monitor what passengers are doing.
iii. The system can better maintain passenger privacy relative to regular cameras, by being able to track user activity without needing to analyze or record the user visually—e.g., user facial features, etc.
iv. The technology can use detailed, e.g., pixel-by-pixel, thermal information as an input for machine learning and image processing techniques, which can be used for automatic tracking of passengers activity and behavior inside the vehicle. For example, the system can be used to automatically track passengers violent activity. In various implementations, whether at a highly automated vehicle, the system can, based on the thermal information, generate an alert to a customer service center (e.g., OnStar® system) and/or automatically stop the vehicle and send an alert to a security entity, such as the police.
v. In highly automated driverless taxis, ride-sharing, or other vehicles, benefits to tracking passenger activity can include, but are not limited to, providing a safer environment inside the cabin, and ensuring that passengers are well aware and ready to leave the taxi when approaching their destination.
vi. In addition to promoting safety and peace of mind, there may be a desire or need to track or analyze passengers' behavior and internal state in highly automated vehicles. The tracking or analyzing may be performed, for instance, to understand how the ride experience was for the passengers. Comfort levels and discomfort or stress can be determined based on temperature of a passenger's skin or other body parts such as forehead temperature, or how such temperatures change over time, and/or in response to certain circumstances. The system can be programmed with data indicating amounts or manner of heat emission that people make, generally or from certain parts of their body, when stressed, for instance. The data may show, for example, that users head temperature increases when angry, frightened, or otherwise stressed or uncomfortable, which may be due to blood rushing to the head, or other physiological reason.
vii. Thermal cameras provide temperature information of all objects in the vehicle cabin (including passengers), which can be especially helpful in addition to visual-light cameras (e.g., RGB or depth cameras), especially in situations when light-cameras are not as well suited, such as in dim light or a dark cabin, as the thermal functions are not affected by illumination conditions.
viii. The system can modify vehicle settings, such as HVAC settings to improve or maximize passenger comfort or infotainment (e.g., volume or radio channel) settings, based on sensed thermal conditions in the vehicle.
ix. Algorithms can differentiate between passengers and other objects (e.g., pet, weapon, luggage) in the cabin based on thermal data, and better perform such differentiation as compared to systems using only a visual-light, or RGB camera.
x. In various implementations, output of the system using the thermal camera is superior to output of a system using a visual-light camera system in detecting users versus non-living objects.
xi. The system is able to, using output from at least one thermal camera, track or analyze passenger behavior, understand some aspects about their internal state (including by monitoring and/or determining state of various passenger modalities—hand, face, body gestures). The system can, consequently, enhance the passenger's overall experience in a highly automated vehicle such as a self-driving taxi.
xii. The system can improve passenger level of safety, such as by the described pre-registration and registration processes.
xiii. The system can improve passenger experience (e.g., lower stress) and convenience (e.g., awakening passenger gently if determined sleeping and approaching their stop), in highly automated or other vehicles.
xiv. In various embodiments, thermal data can be provided for display to (e.g., color image or video) and analysis by a remote computerized system and/or human controller, such as a computer system and personnel of a customer-service center, such as the OnStar® Center. Human personnel can upon a triggering event—e.g., apparent misconduct determined, monitor passenger behavior in real-time via continuing thermal date, or initiate an alert to authorities, those in the vehicle, relevant computing systems, or others.
xv. The system can also monitor the passengers to determine if any passengers leave the vehicle 10 and if any are added to the vehicle. Either situation can be analyzed to determine whether the change is appropriate, such as by determining identification of the passengers leaving/arriving, and comparing the passengers leaving/arriving to who should be in the vehicle based on a manifest or ride plan.
xvi. Thermal cameras can sense a longer range than depth or visual-light cameras, which lose more accuracy with distance.
xvii. Based on conduct, passengers can be associated with a demerit or strike in the system, and possibly disqualified from future use, such as of a particular ride-share or taxi service. The disqualification can be made after a pre-set number of demerits, for instance or, in some implementations, without need for warning, depending on the configuration and severity of the misconduct, for instance.
xviii. Further regarding passenger states and comfort levels, the system can determine, based on the thermal data, changes in temperature level in different portions of a passenger, and based on that, determine that a user has a certain state or comfort level, such as being stressed (one form of discomfort), having fallen asleep or haven just awoken. As referenced, an increase in head temperature may indicate that the user is angry, frightened, stressed, or otherwise uncomfortable, for example. Designers of the system can determine any number of such relationships. In contemplated embodiments, as referenced, the system is configured to learn from interactions with the user to understand how the user responds to certain situations. If a user head temperature increases in a certain manner in response to a certain vehicle maneuver (e.g., passing at high speed on the highway), then the system may create a correlation in the system or a remote database (e.g., user profile), for use by the system to recognize user state or condition going forward. The system can initiate any appropriate action in response to the determinations, such as to adjust a vehicle driving style in order to minimize passenger stress or otherwise improve the passenger experience.
xix. The technology is in various embodiments configured to, in response to determining passenger state(s) or activity(ies), take actions that a human driver would likely take—such as turning down the radio if the person is sleeping, giving them notice before there stop to wake up, asking rowdy customers to calm down, drive slower if passengers appear concerned, etc.
xx. The technology can, in contemplated embodiments, be used in vehicles that are only partially autonomous, or in vehicles that are human driven. In the latter case, the thermal-analysis and action determination can have any or most any of the functions and benefits described herein, including benefits of increasing safety and peace of mind of passengers (or, if a driver, also of the driver), and especially for driver, parenting, or other co-occupant situations, alleviate requirements of the driver, parent, or other passengers to monitor and enforce appropriate (non-driving related) actions of others—e.g., the system automatically notifies a dispatch office or the police of a determined misconduct (and advises at least the driver that the notification is going or went out).
xxi. The system in various embodiments is configured to classify events, such as maneuvers (e.g., turning left, a speed above a certain level, highway driving versus city driving) or other circumstances (e.g., number of passengers, which can affect the fare charged, for instance) based on passenger temperature response. The stored classification can be used by a remote system 50 or mobile device 34 in making future determinations to improve the user experience—e.g., setting vehicle cabin temperature accordingly, matching the passenger with a certain numbers or types of other passengers for rides, driving only within a certain speed range, not making certain driving maneuvers, the like, or other.

### VII. Select Advantages

Many of the benefits and advantages of the present technology are described above. The present section restates some of those and references some others. The benefits described are not exhaustive of the benefits of the present technology.

The technology allows greater customization of autonomous driving experiences to the passenger or passengers riding in the vehicle, and can notify interested parties (parents, vehicle operator, authorities, etc.) of relevant circumstances involving the ride or the passenger(s).

The system can better maintain passenger privacy relative to regular cameras, by being able to track user activity without needing to analyze or record user facial features.

Weapons can be identified based on the thermal data and system coding.

Thermal cameras provide temperature information of all objects in the vehicle cabin (including passengers), which can be especially helpful in addition to visual-light cameras (e.g., RGB or depth cameras), especially in situations when light-cameras are not as well suited, such as in dim light or a dark cabin.

The technology in operation enhances driver and/or passenger satisfaction, including comfort, with using automated driving by adjusting any of a wide variety of vehicle characteristics, such as vehicle driving-style parameters and climate controls.

The technology will lead to increased automated-driving system use. Users are more likely to use or learn about more-advanced autonomous-driving capabilities of the vehicle as well, when they are more comfortable with the automation because of operations and known presence of the system—safety, comfort-providing features, etc.

A relationship between the user(s) and a subject vehicle can be improved—the user will consider the vehicle as more of a trusted tool, assistant, or friend.

The technology can also affect levels of adoption and, related, affect marketing and sales of autonomous-driving-capable vehicles. As users' trust in autonomous-driving systems increases, they are more likely to purchase an autonomous-driving-capable vehicle, purchase another one, or recommend, or model use of, one to others.

Another benefit of system use is that users will not need to invest effort or time, or invest less time and effort, into setting or calibrating automated driver style parameters. This is because, in various embodiments, many of the parameters (e.g., user preferences for HVAC, infotainment, driving style, passenger-mix preference, etc.) are set, and in some cases adjusted, automatically by the system. The automated functionality also minimizes user stress and therein increases user satisfaction and comfort with the autonomous-driving vehicle and functionality.

### VIII. Conclusion

Various embodiments of the present disclosure are disclosed herein.

The disclosed embodiments are merely examples that may be embodied in various and alternative forms, and combinations thereof. The embodiments are merely example illustrations of implementations, set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the thermal-management systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for implementation at a vehicle of transportation, comprising:
a thermal camera arranged in the vehicle to sense intra-vehicle thermal conditions, yielding intra-vehicle thermal data; and
a hardware-based storage device comprising:
a thermal-data analysis module that, when executed by a hardware-based processing unit, determines, based on the intra-vehicle thermal data, an activity or state of one or more vehicle occupants;
an action module that, when executed by the hardware-based processing unit, determines an output action based on the activity or state of at least one of the vehicle occupants; and
an output-interface module that, when executed by the hardware-based processing unit, initiates performing the output action determined.

2. The system of claim 1, wherein:
the hardware-based storage device comprises a database module that, when executed by a hardware-based processing unit, obtains pre-stored occupant data corresponding to one of the occupants of the vehicle; and
determining the output action is based on the pre-stored occupant data and the occupant activity or state determined.

3. The system of claim 1, wherein:
the thermal-data analysis module, when executed by the hardware-based processing unit determines, based on the intra-vehicle thermal data, an activity or state for each of multiple vehicle occupants; and
the action module, when executed by the hardware-based processing unit, determines the output action based on the activity or state of at least one of the multiple vehicle occupants.

4. The system of claim 1, wherein the thermal-data analysis module, in determining the activity or state of one or more vehicle occupants, determines that at least one of the vehicle occupants is:
sleeping;
misbehaving;
not feeling well; or
uncomfortable.

5. The system of claim 1, wherein the thermal-data analysis module, in determining the activity or state of one or more vehicle occupants, determines that at least one of the vehicle occupants is uncomfortable.

6. The system of claim 5, wherein the thermal-data analysis module, in determining the activity or state of one or more vehicle occupants, determines that at least one of the vehicle occupants is uncomfortable with a present or recent vehicle driving maneuver.

7. The system of claim 1 wherein:
the action module, in determining the output action based on the activity or state of at least one of the vehicle occupants, determines to provide an alert or notification to at least one vehicle occupant regarding the activity or state determined; and
the output-interface module, in initiating performing the output action determined, initiates providing the alert or notification by way of vehicle communication hardware or an occupant device.

8. The system of claim 1, wherein:
the action module, in determining the output action based on the activity or state of at least one of the vehicle occupants, determines to change a vehicle driving setting affecting autonomous driving; and
the output-interface module, in initiating performing the output action determined, initiates changing the driving setting.

9. The system of claim 1, wherein:
the action module, in determining the output action based on the activity or state of at least one of the vehicle occupants, determines to deliver a message to an authority of supervisory entity regarding the activity or state determined; and
the output-interface module, in initiating performing the output action determined, initiates delivering the message to the entity.

10. The system of claim 9, wherein the entity comprises at least one of:
a first-responder;
a remote customer-service center;
a co-worker of the occupant;
a relative of the occupant; and
a friend of the occupant.

11. The system of claim 1, wherein:
the vehicle of transportation is a subject vehicle;
the occupant activity or state comprises occupant misconduct;
the action module, in determining the output action based on the activity or state of at least one of the vehicle occupants, determines to disqualify the occupant from present or future use of the subject vehicle or a group of vehicles including the subject vehicle; and
the output-interface module, in initiating performing the output action determined, initiates disqualifying the occupant from present or future use of the subject vehicle or a group of vehicles including the subject vehicle.

12. The system of claim 1, wherein:
the thermal-data analysis module, in determining the activity or state of one or more vehicle occupants based on the intra-vehicle thermal data determines that an occupant is sleeping;
the action module, in determining the output action based on the activity or state of at least one of the vehicle occupants, determines to provide an alert to awaken the occupant sleeping; and
the output-interface module, in initiating performing the output action determined, initiates providing the alert by way of a vehicle human-machine interface.

13. The system of claim 1, wherein:
the thermal-data analysis module, in determining the activity or state of one or more vehicle occupants based on the intra-vehicle thermal data determines that an occupant is sleeping;
the action module, in determining the output action, determines, based also on data indicating that a stop for the sleeping occupant is approaching or has been reached, to provide a notification, to the occupant, as part of awakening the occupant sleeping and advising the occupant being awaken of the stop; and
the output-interface module, in initiating performing the output action determined, initiates providing the notification by way of vehicle communication hardware or an occupant device.

14. The system of claim 1, wherein:
the action module, in determining the output action, determines, based on the intra-vehicle thermal data, to adjust a vehicle climate-control system; and
the output-interface module, in initiating performing the output action determined, initiates adjusting the vehicle climate control system.

15. The system of claim 1, wherein:
the action module, in determining the output action, determines, based on the intra-vehicle thermal data, to adjust a vehicle infotainment system; and
the output-interface module, in initiating performing the output action determined, initiates adjusting the vehicle infotainment system.

16. The system of claim 1, wherein:
wherein the output action is a second output action;
the thermal-data analysis module, when executed by the hardware-based processing unit, determines, based on the intra-vehicle thermal data, an identity of an analyzed person being one of the occupants or attempting to become a vehicle occupant; and
the action module, when executed by the hardware-based processing unit:
compares the identity determined to an expected identity for the analyzed person, yielding a comparison; and
determines a first output action in response to the comparison revealing a mismatch between the identity determined and the expected identity; and
an output-interface module that, when executed by the hardware-based processing unit, initiates performing the first output action and the second output action.

17. The system of claim 16, wherein the first output action comprises at least one action selected from a group consisting of:
notifying the analyzed person of the mismatch;
notifying at least one vehicle occupant, not including the analyzed person, of the mismatch;
notifying a remote entity of the mismatch;
locking vehicle doors;
sounding a vehicle alarm;
establishing a setting so that the vehicle is not driven presently; and
stopping vehicle driving if driving has already commenced.

18. The system of claim 16, wherein the action module, when executed by the hardware-based processing unit, obtains the expected identify from a vehicle itinerary or manifest indicating one or more persons expected for present vehicle use.

19. A system, for implementation at a vehicle of transportation, comprising:
a thermal camera arranged in the vehicle to sense intra-vehicle thermal conditions, yielding intra-vehicle thermal data; and
a hardware-based storage device comprising:
a thermal-data analysis module that, when executed by a hardware-based processing unit, determines, based on the intra-vehicle thermal data, an activity or state of one or more vehicle occupants; and
an action module that, when executed by the hardware-based processing unit, determines an output action based on the activity or state of at least one of the vehicle occupants.

20. A system, for implementation at a vehicle of transportation, comprising:
a thermal camera arranged in the vehicle to sense intra-vehicle thermal conditions, yielding intra-vehicle thermal data; and
a hardware-based storage device comprising:
a thermal-data analysis module that, when executed by a hardware-based processing unit, determines, based on the intra-vehicle thermal data, an activity or state of one or more vehicle occupants.
